(19) United States
(12) Patent Application Publication
(10) Pub. No.: US 2003/0066431 A1
(43) Pub. Date: Apr. 10, 2003

(54) Coffee maker

(75) Inventors: Robert F. Fanzutti, Naugatuck, CT (US); Paul F. Garneau, East Haven, CT (US); Joseph Gelb JR., Milford, CT (US); Peter Hohlfeld, Oxford, CT (US); Bradford Mitchell, Hallandale, FL (US); Marc P. Ortins, Woburn, MA (US); Scott J. Duplantis, Miramar, FL (US); Steven L. Hecker, Ft. Lauderdale, FL (US)

Correspondence Address: Barry E. Deutsch, Esq., Suite 104, 35 Thorpe Avenue, Wallingford, CT, 06492, US

(73) Assignee: Attention: Mr. John P. Garniewski

(21) Appl. No.: 10/260,045

(22) Filed: Sep. 30, 2002

Related U.S. Application Data
(60) Provisional application No. 60/327,538, filed on Oct. 5, 2001.

(51) Int. Cl. A23F 3/00

(52) U.S. Cl. 99/279

(57) ABSTRACT

A coffee maker including a frame; a water reservoir connected to the frame; a peristaltic pump connected to the water reservoir; and a heater connected to the peristaltic pump. The frame comprises a coffee pod holder for removably holding a coffee grounds containing pod. Hot water can be received from the heater into the coffee grounds containing pod and liquid coffee can pass out of the coffee grounds containing pod.

### CROSS-REFERENCE TO RELATED APPLICATION

This application claims the benefit under 35 USC §119(e) of U.S. Provisional Patent Application No. 60/327,538 filed Oct. 5, 2001.

### BACKGROUND OF THE INVENTION

1. Field of the Invention

The present invention relates to coffee makers and, more particularly, to a coffee maker which is adapted to receive disposable coffee pods.

2. Brief Description of Prior Developments

U.S. Pat. No. 4,975,296 discloses a coffee dispensing machine with a peristaltic pump. U.S. Pat. No. 5,974,950 discloses a beverage brewing machine with a coffee packet having bar code. U.S. Pat. No. 5,197,374 discloses an apparatus for extracting cartridges containing coffee.

A problem exists with coffee brewing machines in that it is difficult to produce single servings with repeatable good quality. There is a need to provide a single serve coffee brewing machine which can produce good quality coffee with repeatable consistency, including temperature and taste. There is also a desire to provide a single serve coffee brewing machine which can produce good quality of different types of coffee, including black coffee and creamy coffee.

### SUMMARY OF THE INVENTION

In accordance with one aspect of the present invention, a coffee maker is provided including a frame; a water reservoir connected to the frame; a peristaltic pump connected to the water reservoir; and a heater connected to the peristaltic pump. The frame comprises a coffee pod holder for removably holding a coffee grounds containing pod. Hot water can be received from the heater into the coffee grounds containing pod and liquid coffee can pass out of the-coffee grounds containing pod.

In accordance with another aspect of the present invention, a coffee maker is provided comprising a frame; a fluid conduit system extending through the frame, a coffee pod holder connected to the frame, and a coffee pod piercing system. The fluid conduit system comprises a water heater. The coffee pod holder is adapted to simultaneously hold at least two pods. The coffee pod piercing system is connected to the frame and has at least two needles connected to the fluid conduit system which are adapted to respectively pierce through the at least two pods in the coffee pod holder and allow heated water to separately flow into the at least two pods.

In accordance with another aspect of the present invention, a coffee maker is provided comprising a frame; a water heater connected to the frame, a fluid conduit system connected to the water heater, and a controller. The water heater is arranged in a general vertical orientation with an inlet at a bottom and an outlet at a top. The fluid conduit system comprises a liquid pump for pumping water into the inlet of the water heater. The controller is connected to the pump and the water heater. The controller is adapted to control the water heater and the pump for delivering about eight ounces of water from the outlet of the water heater at about 1800 F in about one minute or less from a water supply at about room temperature.

In accordance with another aspect of the present invention, a coffee maker is provided comprising a frame; a fluid conduit system extending through the frame; a coffee pod holder connected to the frame; and a coffee pod sensor. The coffee pod holder is adapted to, simultaneously hold at least two separate pods. The coffee pod sensor is adapted to separately sense the presence or absence of the at least two pods in the coffee pod holder.

In accordance with another aspect of the present invention, a coffee maker is provided comprising a frame; a fluid conduit system extending through the frame; a coffee pod holder connected to the frame, the coffee pod holder being adapted to hold at least one pod; a coffee pod piercing system connected to the frame and having at least one needle connected to the fluid conduit system which is adapted to pierce through the at least one pod in the coffee pod holder and allow heated water to separately flow into the pod; and a system for preventing a user from contacting the needle when the coffee pod holder is in an open position. The fluid conduit system comprising a water heater.

In accordance with another aspect of the present invention, a coffee maker is provided comprising a frame comprising a coffee pod holder; a fluid conduit system extending through the frame, the fluid conduit system comprising a water heater; a coffee pod piercing system connected to the frame, the coffee pod piercing system comprising a needle for piercing into at least one pod in the coffee pod holder and a handle connected to the needle for moving the needle; and a system for automatically moving the needle out of engagement with the pod upon completion of a brewing cycle. The handle is moved when the needle is moved such that the handle forms an indicator for indicating completion of the brewing cycle.

### BRIEF DESCRIPTION OF THE DRAWINGS

Aspects of the present invention are explained in the following description, taken in connection with the accompanying drawings, wherein:

FIG. 1 is a perspective view of a coffee maker incorporating features of the present invention;

FIG. 2 is an exploded perspective view of portions of the coffee maker shown in FIG. 1;

FIG. 3 is an exploded perspective view of the pump and motor assembly shown in FIG. 2;

FIG. 4 is an exploded perspective view of the heater shown in FIG. 2;

FIG. 5 is an exploded perspective view of front top portions of the coffee maker shown in FIG. 1;

FIG. 6 is an exploded perspective view of the diverter shown in FIG. 5;

FIG. 6A is a schematic cross sectional view of the diverter shown in FIG. 6 at a first position;

FIG. 6B is a schematic cross sectional view of the diverter shown in FIG. 6A at a second position;

FIG. 7 is a block diagram of the control system of the coffee maker shown in FIG. 1;

FIG. 8 is a perspective view of an alternate embodiment of the tray shown in FIG. 5;

FIG. 9 is a cross sectional view of a top front end of an alternate embodiment of a coffee maker incorporating features of the present invention;

FIG. 10 is a cross sectional view of the top front end of the coffee maker shown in FIG. 9 with the needle carriage and needles in a down position;

FIG. 11 is a cross sectional view of a top front end of another alternate embodiment of a coffee maker incorporating features of the present invention;

FIG. 12 is a cross sectional view of the top front end of the coffee maker shown in FIG. 11 with the needle carriage and needles in a down position;

FIG. 13 is a cross sectional view of the top front end of the coffee maker shown in FIG. 11 with the needle carriage and lid in an up position;

FIG. 14 is a cross sectional view of a top front end of another alternate embodiment of a coffee maker incorporating features of the present invention with the lid in an up position;

FIG. 15 is a perspective view of an alternate embodiment of the present invention;

FIG. 16 is a perspective view of the front top end of another alternate embodiment of the present invention;

FIG. 17 is a diagrammatic view of a water flow path through a coffee maker incorporating features of the present invention;

FIG. 18 is an operational flow chart of one method of a main routine which can be used in operating a coffee maker incorporating features of the present invention;

FIG. 19 is an operational flow chart of one method when brewing black coffee with a coffee maker incorporating features of the present invention; and

FIG. 20 is an operational flow chart of one method when brewing creamy coffee with a coffee maker incorporating features of the present invention.

### DETAILED DESCRIPTION OF THE PREFERRED EMBODIMENT

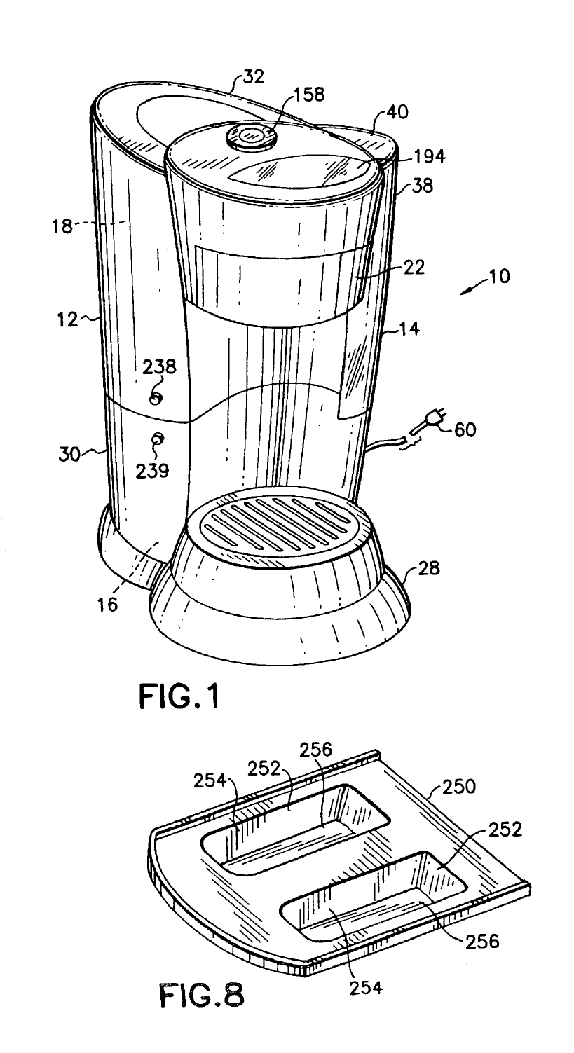

Referring to FIG. 1, there is shown a perspective view of a coffee maker 10 incorporating features of the present invention. Although the present invention will be described with reference to the embodiments shown in the drawings, it should be understood that the present invention can be embodied in many alternate forms of embodiments. In addition, any suitable size, shape or type of elements or materials could be used.

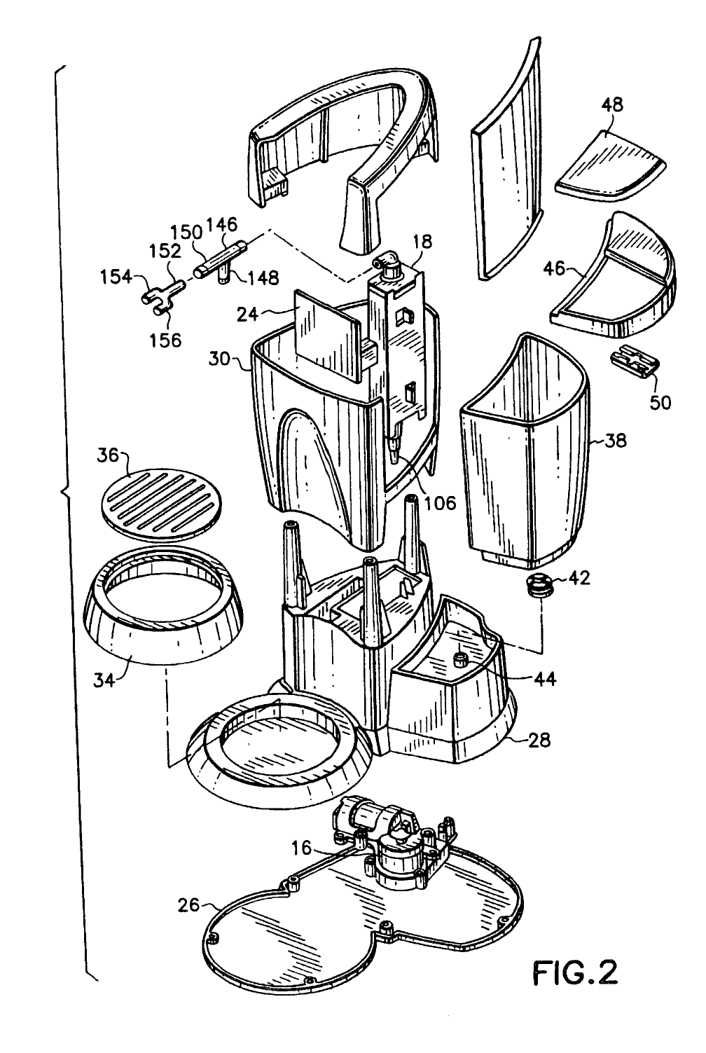

Referring also to FIGS. 2 and 5, the coffee maker 10 generally comprises a frame or housing 12, a water reservoir 14, a motor and pump assembly 16, a heater 18, a diverter 20, a coffee pod section 22, and a controller 24. The frame 12 generally comprises a base 26, a bottom housing section 28, a middle housing section 30 and a top housing section 32. However, in alternate embodiments, the frame could be comprised of any suitable number or type of members. In the embodiment shown, the frame 12 also comprises a coffee cup stand. The coffee cup stand comprises a standoff member 34 and a spill grate 36. In the embodiment shown, the coffee maker 10 does not comprise a warmer for a coffee pot or coffee cup.

However, in an alternate embodiment, a warmer could be provided, such as for use with a glass coffee mug. In the embodiment shown, the water reservoir 14 is removably connected to one side of the bottom housing section 28. In an alternate embodiment, the water reservoir might not be removably connected to the frame 12. The water reservoir 14 generally comprises a container 38 and a lid 40. The bottom of the container 38 has a water outlet with a seal 42. The water outlet and seal 42 are connected to a water inlet 44 in the bottom housing section 28. The lid 40 comprises a first housing piece 46 and a movable cover 48 connected to the first housing piece 46 by a hinge 50.

In alternate embodiments, the water reservoir could be comprised of any suitable type or number of components. In one type of alternate embodiment, the coffee maker 10 could comprise a sensor for sensing the water level in the water reservoir 14, such as a float valve. One such type of water level sensor could comprise a magnet connected to a float inside the container 38, and a reed switch connected to the frame 12 outside of the container 38. The reed switch could be connected to the controller 24. In an alternate embodiment, any suitable type of a water level sensor could be provided. In another alternate embodiment, the coffee maker could be connectable to a supply of water, such as a hose connected to a building's water supply system.

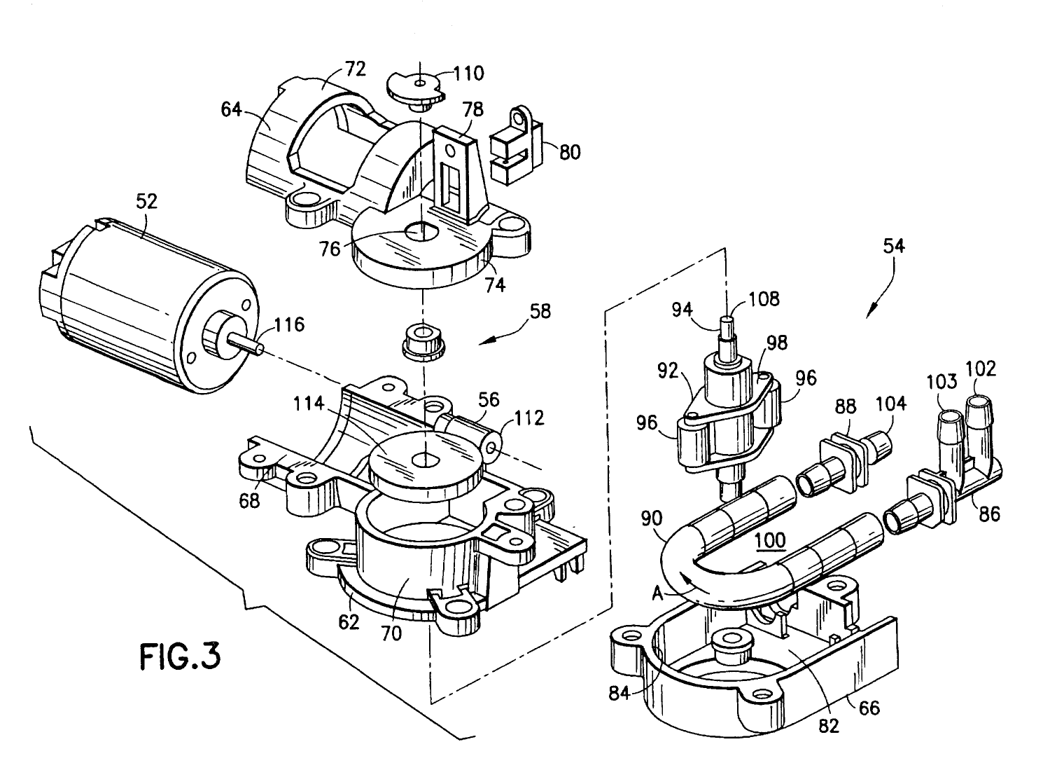

Referring also to FIG. 3, an exploded perspective view of the pump and motor assembly 16 is shown. The assembly 16 generally comprises a motor 52, a pump 54, a transmission 56, and a connecting housing 58. The motor 52 is preferably a DC high voltage constant speed motor. However, in alternate embodiments, any suitable type of motor could be used. For example, the motor could be an AC constant speed motor or a variable speed motor. The controller can control the motor speed. The motor 52 is connected to the electrical cord and electrical outlet plug 60 (see FIG. 1). The motor 52 is also connected to the controller 24. The controller 24 controls activation, deactivation, and the speed of the motor 52.

The connecting housing 58 generally comprises a first member 62, a second member 64, and a third member 66. The first member 62 comprises a first clamshell section 68 for the motor 52. The first member 62 also comprises a second section 70. The second section 70 forms a housing for components of the transmission 56.

The second member 64 is connected to a top side of the first member 62. The second-member 64 comprises a first clamshell section 72 and a second section 74. The two clamshell sections 68, 72 capture the motor 52 therebetween. The second section 74 of the second member 64 covers the second section 70. Second section 74 has an aperture 76 therethrough. The second section 74 also comprises a mount 78 on its top side. A sensor 80 is connected to the mount 78. The sensor 80 in the embodiment shown is an optical sensor. However, in alternate embodiments, any suitable type of sensor could be provided, such as a Hall effect sensor for example. The optical sensor 80 is adapted to sense rotation of the pump 54. However, in alternate embodiments, the pump sensor could be a Hall effect sensor or a magnetic sensor. The sensor 80 is operably connected to the controller 24. A flow meter could also be placed in the tubing.

The third member 66 is connected to the bottom side of the first member 62. The third member 66 comprises a main pumping area 82 with a curved interior wall 84. The third member 66 forms a portion of the pump 54. Water conduit tube connectors 86, 88 are connected to the third member 66. In alternate embodiments, any suitable type of connecting housing could be provided. Alternatively, the connecting feature of the connecting housing 58 could be integrally incorporated into the frame 12.

The pump 54, in the embodiment shown, is a peristaltic pump. However, in alternate embodiments, any suitable type of pump could be provided. For example, the pump could comprise a piston pump or a diaphragm pump. However, in such alternate embodiments, a secondary water metering system should be provided. With the use of a peristaltic pump, such as the pump 54, a secondary metering system is not required. The pump 54, because of its precision in pumping water relative to its moving, can be used as a meter to measure the amount of water through the pump as the pump moves. By not having to provide a separate water meter, this can reduce the size and weight of the coffee maker, as well as reduce the cost of the components and assembly of the coffee maker.

The pump 54 generally comprises the third member 66, the two connectors 86, 88, a tube 90, and a pumping shaft assembly 92. The tube 90 is comprised of a resilient flexible material, such as a polymer material. Opposite ends of the tube 90 are connected to respective ones of the connectors 86, 88. An outer side of the tube 90 is located against the curved interior wall 84 of the third member 66.

The pumping shaft assembly 92 generally comprises a main drive shaft 94, and two or more rollers 96 connected to the main drive shaft 94 by a frame 98. The rollers 96 are rotatably connected to the frame 98. The pumping shaft assembly 92 extends into the general U-shaped area 100 of the tube 90. The rollers 96 are aligned in a same plane as the tube 90. As the pumping shaft assembly 92 rotates, the rollers 96 contact the interior side of the tube 90 at the area 100 and compress the tube 90 against the interior wall 84. This crimps the tube 90 between the rollers 96 and the wall 84. However, the crimp is a moving crimp. The crimp moves with the rollers 96 as the rollers are rotated about the longitudinal axis of the shaft 94. The moving crimp pushes water in the tube 90 in a forward direction as indicated by arrow A. One inlet 102 of the first tube connector 86 is connected to the water inlet 44. The outlet 104 of the second connector 88 is connected to the heater 18 by a tube 106 (see FIG. 2).

A top end 108 of the main drive shaft 94 extends through the aperture 76 in the second member 64 and is connected to a member 110. In the embodiment shown, the member 110 is an optical disk. The disk 110 is suitably located relative to the sensor 80 to allow the sensor 80 to detect the angular position or rotation of the disk 110. Thus, the angular position or rotation of the shaft 94 and/or the rotational velocity of the pumping shaft assembly 92 can be detected, such as when using an LED and optical sensor phototransistor. If a Hall effect sensor is used, a magnet would be needed to generate pulses.

The transmission 56, in the embodiment shown, generally comprises two gears 112, 114. The first gear 112 is connected to the output shaft 116 of the motor 52. The second gear 114 is connected to the main drive shaft 94 of the pumping shaft assembly 92. The two gears 112, 114 are operably connected to each other inside the second section 70 of the first connecting housing member 62. When the motor 52 rotates the output shaft 116, the gears 112, 114 cause a corresponding rotation of the main drive shaft 94. This, in turn, causes the frame 98 to axially rotate about the longitudinal axis of the shaft 94. This rotates the rollers 96 about the longitudinal axis of the shaft 94. However, in alternate embodiments, any suitable type of transmission could be provided.

One of the features of the peristaltic pump 54 is the ability to control the flow rate of water through the pump. Each rotation of the pumping shaft assembly 92 (or portion of rotation) generates an exact amount of water being pumped by the pump. The number of rotations are counted by the sensor and communicated back to the controller. In a preferred embodiment, the flow rate is a constant flow rate of about 4.4-5.6 ml/sec. This flow rate is faster than conventional electric coffee makers. However, any suitable type of flow rate could be provided. The use of a peristaltic pump allows the speed of the pump to be relatively precisely controlled and the volume of water being pumped by the pump can also be relatively precisely controlled. In addition, the use of a peristaltic pump allows for relatively accurate and precise measurement or determination of the volume or quantity of water being pumped through the pump based upon measuring rotation of the pumping shaft assembly 92. A peristaltic pump also reduces the number of parts that come into contact with the water. However, in alternate embodiments, any suitable means could be used to measure the quantity of water being pumped through the pump.

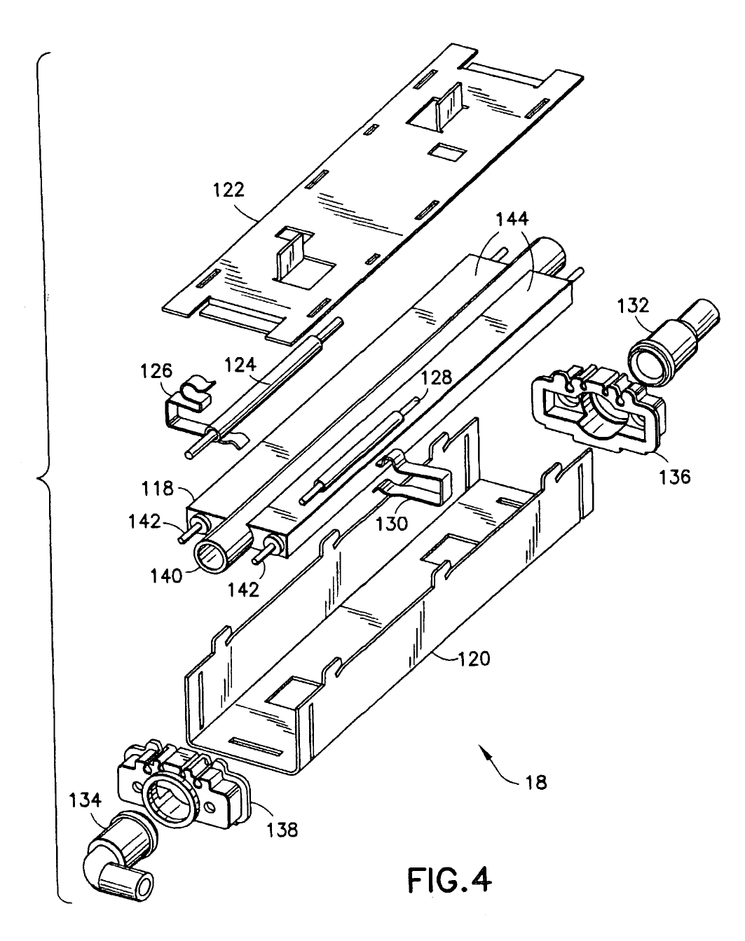

Referring now also to FIG. 4, an exploded perspective view of the heater 18 is shown. The heater 18 generally comprises a water heating subassembly 118, heat shield members 120, 122, thermal cutoffs (TCO) 124, a TCO clip 126, a thermistor 128, a thermistor clip 130, top and bottom water tube fittings 132, 134, and top and bottom end caps 136, 138. However, in alternate embodiments, the heater could comprise additional or alternative components.

The thermistor is used to measure the temperature of the hot water generator for determining an end of a pre-heat cycle and, to help insure that the hot water generator is at a temperature for generating the hot water in a temperature range to provide proper brewing and a preferred coffee temperature. If too hot, the power to the heating elements can be turned OFF. If too cool, the pump can be stopped or its speed lowered. The thermistor also provides over-temperature sensing, such as when water flow to the heater stops (such as when the water reservoir becomes empty.

The water heating subassembly 118 generally comprises a water conduit tube 140, two heating elements 142, and blocks 144 of heat conductive material which connect the heating elements 142 to the water conduit tube 140. In a preferred embodiment, the two heating elements 142 are Calrods. However, in alternate embodiments, any suitable type of heating element could be used. In addition, more or less than two heating elements could be used. In a preferred embodiment, the blocks 144 of heat conductive material are comprised of cast aluminum. However, in alternate embodiments, the blocks 144 could be comprised of any suitable type of material. In addition, more or less than two blocks could be used. Blocks 144 function as mechanical attachments for the heating elements 142 to the water conduit tube 140. In addition, the blocks 144 also function as heat transfer elements to transfer heat from the heating elements 142 to the water conduit tube 140. The, heating elements 142 are connected to the controller 24. The controller 24 controls supply of electricity to the heating elements 142. In an alternate embodiment, any suitable type of water heating subassembly could be provided.

The TCO 124 and the thermistor 128 are mechanically attached to the subassembly 118 by the two clips 126, 130. However, in alternate embodiments, any suitable means could be used to attach the TCO 124 and the thermistor 128 to the subassembly 118. For example, the TCO 124 and/or the thermistor 128 could be integrally formed with the subassembly 118. The TCO 124 and the thermistor 128 are operably electrically connected to the controller 24. In an alternate embodiment, any suitable type of a temperature sensor or thermal fuse could be provided.

The shield members 120, 122 and end caps 136, 138 substantially surround the water heating subassembly 118. The two fittings 132, 134 are connected to opposite ends of the water conduit tube 140. The bottom tube fitting 132 is connected to the tube 106. The top tube fitting 134 is connected to a T shaped pressure relief valve 146 (see FIG. 2). One section 148 of the valve 146 is connected by a tube (not shown) to the second inlet 103 into the tube connector 86 at the pump 54 (see FIG. 3). Another section 150 of the valve 146 is connected to a T shaped splitter tube 152. Outlet sections 154, 156 of the T shaped tube 152 are connected to the diverter 20 (see FIG. 5).

As seen best in FIG. 2, the heater 18 is orientated in a substantially vertical orientation with its water inlet at its bottom end and its heated water outlet at its top end. However, in an alternate embodiment, the heater could be orientated in any suitable orientation. The heater in this embodiment has a substantially straight shape. However, in an alternate embodiment, the heater could have any suitable type of shape, such as L shaped for example. For the vertical heater shown, the water being pushed upward into the inlet 132 contacts the entire inner diameter surface of the water conduit tube 140. In addition, the water is retained in the water conduit tube 140 by gravity until the water is pushed out of the top outlet 134 by new incoming water. This ensures maximum heat transfer to the water in the water conduit tube 140 before the water flows out of the top outlet fitting 134.

In a preferred embodiment, the heater is a 1400 Watt heater at 120 Volts. However, in alternate embodiments, any suitable heater could be provided. A 1400 Watt heater allows the heater to be able to increase in temperature from room temperature to heat water to 180° F. within one minute. In alternate embodiments, temperature sensors could be provided in the water reservoir, at the inlet into the heater, and/or at the outlet from the heater for more precise hot water generation. Of course, not every electrical outlet has exactly 120 Volts. In addition, power from the power company can fluctuate, such as during a brownout. Manufacturing tolerances for the heater are preferably +5% to −10% Wattage variation. Thus, for a same type of heater from the same manufacturer, at 128 Volts the heater would have an output of 1950 Watts, and at 107 Volts the heater would have an output of 1100 Watts. The present invention recognizes this and uses the controller to compensate by controlling operation of the pump and heater. The thermistor monitors the hot water generator and sends signals to the controller such that the controller can take action to adjust or correct the temperature of the water while the water is still inside the hot water generator. This control delivers a relatively accurate desired temperature of the hot water. This results in the best predetermine quality of brewed coffee even though the supply of electricity may not always be the same.

In a preferred embodiment, the controller can control the heater 18 and/or the pump 54, based at least partially upon the temperature of the heater sensed by the thermistor 128. In a preferred embodiment, the controller 24 performs a pre-heat cycle of the heater before the pump 54 is actuated, such as about one minute. The pre-heat cycle could be longer or shorter than one minute, such as merely 10 seconds for example. In an alternate embodiment, a pre-heat cycle might not be provided. More specifically, the pump 54 is not turned on until the heater 18 has reached a predetermined minimum temperature. After the predetermined minimum temperature is reached, the controller 24 then actuates the pump 54 to start pumping water into the heater. The controller continuously monitors the temperature of the heater. If the temperature of the heater goes above a predetermined out-of-range upper temperature, the controller shuts the heater OFF, but continues pumping water through the pump to the heater. If the temperature of the heater goes below a predetermined out-of-range lower temperature, the controller shuts the pump OFF until the temperature of the heater rises again. Then the pump is turned ON again.

In the situation when the coffee maker is used again when the heater is still hot from a previous brewing cycle, the controller could turn the pump ON without use of the pre-heat cycle; such as when a user starts the coffee maker when the temperature of the heater is between the out-of-range lower and upper temperatures. The out-of-range lower and upper temperatures could be fixed or could be varied based upon predetermined conditions, such as pod recognition or coffee maker system state.

One of the features of the present invention is the quality of the coffee that is brewed. Different coffees, such as flavored coffees or mixtures of coffee and condiments in a pod(s), may require different brewing conditions. These brewing conditions can be determined by the coffee pod manufacturer and the coffee maker manufacturer and preprogrammed into the coffee maker and coffee pod shape for recognition by the coffee maker. In order to obtain the best quality coffee, the present invention allows much greater control of the brewing process by use of pod recognition, relatively precise water delivery (both rate and quantity), and adjustments based upon heater temperature. The present invention can also allow for automatic small or larger quantity recognition, such as merely based upon recognition of the pod(s) or number of pod(s) placed in the coffee maker. The present invention may also allow a user to select certain features, such as small or large, or mild or strong.

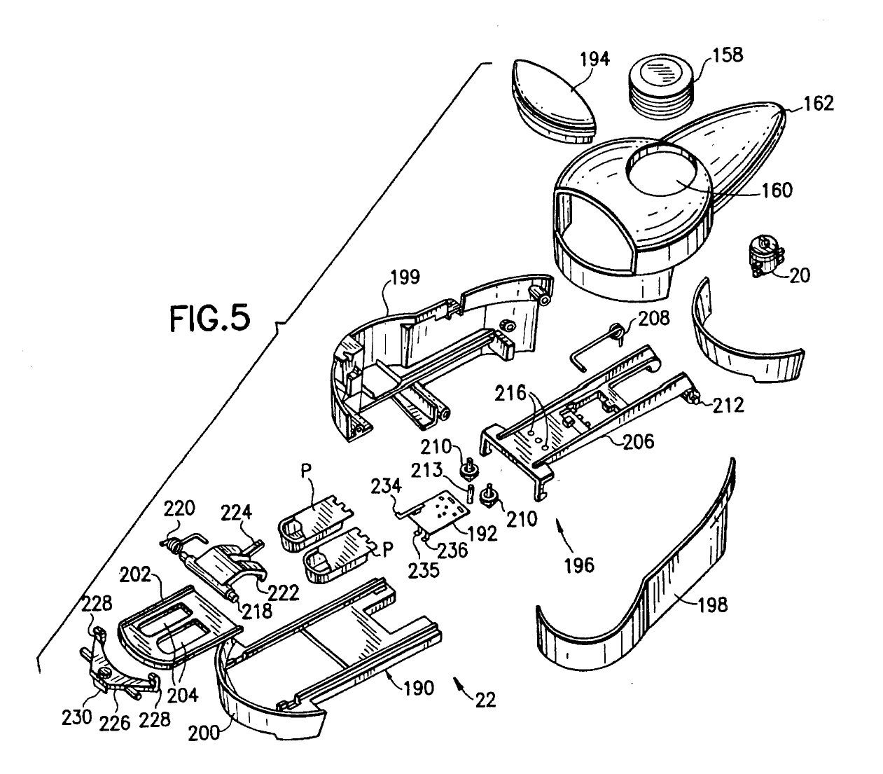

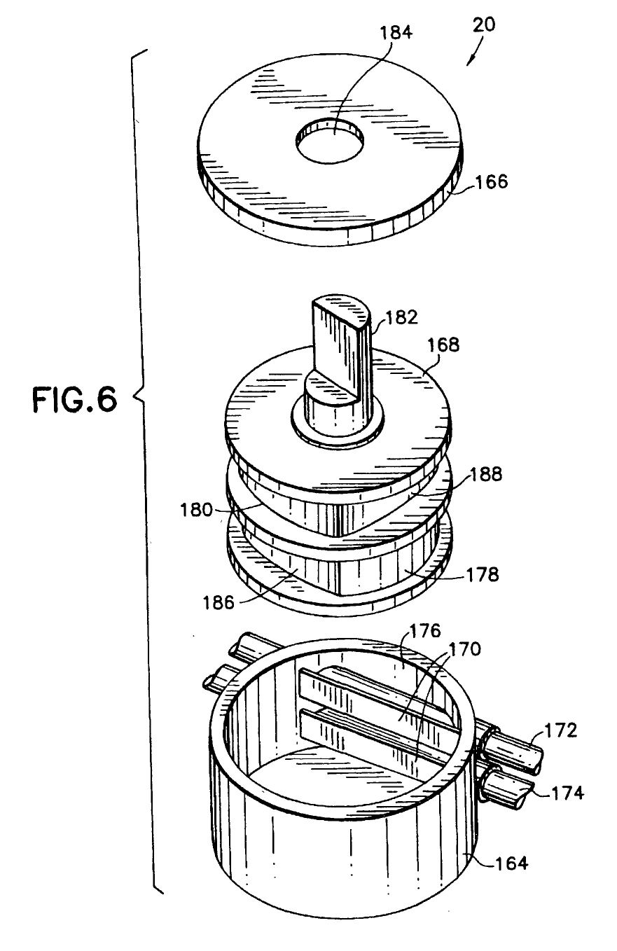

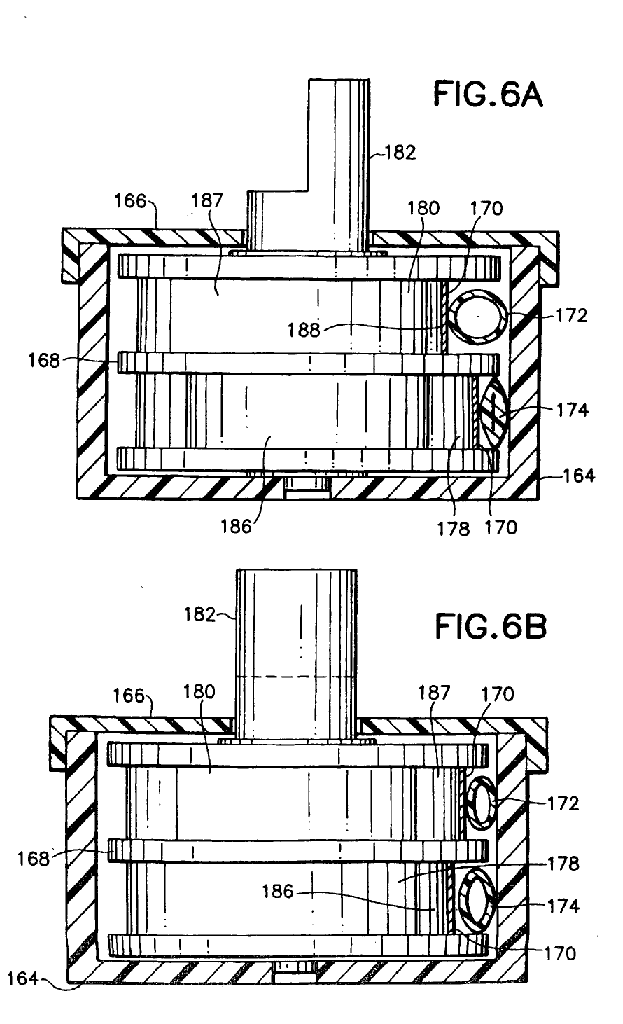

Referring also to FIG. 5, the diverter 20 is connected to a user actuatable selector 158. The selector 158 extends through an aperture 160 in a top member 162 of the frame 12. Referring also to FIGS. 6, 6A and 6B, the diverter 20 generally comprises a frame comprising a container 164 and a cap 166, a cam member 168, flexible protectors 170, and water conduit tubes 172, 174. The tubes 172, 174 are respectively connected to the outlet sections 154, 156 of the T shaped splitter tube 152. The container 164 comprises apertures for the tubes 172, 174 to extend into and out of an interior area of the container 164. The flexible protectors 170 are mounted in the interior area of the container 164. The protectors 170 are preferably comprised of sheet metal. However, in alternate embodiments, any suitable material could be used. The protectors 170 are located against sides of the tubes 172, 174 facing the center of the container 164. The protectors 170 are adapted to resiliently flex outward to press the tubes 172, 174 against the interior side 176 of the container 164. This can crimp the tubes 172, 174 closed to stop or reduce the flow rate of water flowing through the tubes.

The cam member 168 generally comprises two cam sections 178, 180 and a control shaft 182. The control shaft 182 extends through an aperture 184 in the cap 166. The control shaft 182 is connected to the selector 158. The selector 158 can be axially rotated to rotate the cam member 168 in the container 164. In an alternate embodiment, any suitable type of user actuatable selector for controlling or moving the diverter 20 could be provided. For example, in an alternate embodiment, the manual selector 158 could be replaced by an automatic selector connected to the controller 24. In another alternate embodiment a feedback from the selector 158 or the tubes 172, 174 to the controller could be provided to adjust the heater temperature or the pump operation for additional control or monitoring, such as based upon a mild or medium or strong setting selected by a user, or any other user selected setting.

In alternate embodiments, more or less than two cam sections could be provided. In addition, the cam sections could be offset from each other at any suitable angle, or could be orientated relative to each other in any suitable offset orientation. In the embodiment shown, each cam section 178, 180 is substantially circular shaped or round disk shaped except at recessed areas 186, 178, 188.

In the embodiment shown, the cam member 168 is movable between the two positions shown in FIGS. 6A, 6B. In the first position shown in FIG. 6A, the recessed area 186 of the bottom cam section 178 is spaced from the bottom protector 170. Also in the first position, the recessed area 187 of the top cam section 18 is spaced from the top protector 170. However, the recessed area 188 is located against the top protector 170. In this position, the bottom cam 178 presses the bottom protectors 170 outward to crimp or close the bottom tube 174. The top cam 180 does not press the top protector 170 outward. Therefore, the top tube 172 is substantially open. Thus, in this first position, hot water from the heater 18 is allowed to flow through the top tube 172, but is not allowed to flow through the bottom tube 174.

In the second position shown in FIG. 6B, the recessed area 186 of the bottom cam section 178 is located at the bottom protector 170. The recessed area 188 of the top cam section 180 is spaced from the top protector 170. However, the recessed area 187 is located at the top protector 170. In this embodiment, the recessed area 186 is slightly deeper than the recessed area 187. The cam sections 178, 180 cam the protectors 170 outward, but only partially. In the embodiment shown, the top tube 172 is closed about 60% and the bottom tube 174 is closed about 40%. However, in alternate embodiments, any suitable type of percentages or related percentages could be provided. For example, ratios such as 50%/50% or 75%/25% could be provided.

With the configuration noted above, 40% of the hot water from the heater 18 can flow through the top tube 172 and 60% of the hot water from the heater can flow through the bottom tube 174. The diverter 20 can be switched between the first and second positions by the user merely rotating the selector 158. The protectors 170 protect the tubes 172, 174 from friction of the cam member 168 as the cam member is rotated between the first and second positions. This prevents the cam member 168 from wearing a hole through the tubes 172, 174.

In one type of preferred embodiment, the selector 158 is only adapted to provide two settings; a 100%/0% ratio at a first setting, and a 50%/50% ratio at a second setting. With this embodiment, only one tube 172 or 174 needs to be crimped and, the crimp at the 100%/0% first setting is a total crimp closure of one tube to stop the flow of water in that tube.

Referring back to FIG. 5, the coffee pod section 22 generally comprises a drawer 190, a sensor 192, an actuator 194 and a piercing assembly 196. The drawer 190 is slidingly connected to two housing members 198, 199 of the frame 12. However, in an alternate embodiment, any suitable movable connection of the drawer to the frame 12 could be provided. In the embodiment shown, the drawer 190 generally comprises a first member 200 and a tray 202 connected to the first member 200. The first member 200 comprises rails which are slightly mounted with the housing members 198, 199. The tray 202 comprises two apertures 204. The tray 202 is removably connected to the first member 200 such that the tray 202 can be cleaned. However, in an alternate embodiment, the tray 202 could be integrally formed with the first member 200.

The apertures 204 are suitably sized and shaped to respectively receive a coffee grounds containing pod P therein.

The pods P are coffee delivery vehicles which can contain any suitable type of ground coffee beans, such as flavored coffees. One or more of the pods P can also comprise other components, such as a nondairy creamer, sugar, artificial sweetener, or any other suitable coffee related condiment. Alternatively, a pod could be provided with ground tea leaves. Of course, these are only examples of different items which could be provided in the pods. In alternate embodiments, any suitable material, intended to be mixed or brewed with hot water, could be provided in a pod.

Lips located on the top side of the pods P can rest against the top side of the tray 202. Thus, the pods P can be relatively easily inserted into and removed from the apertures 204. However, in alternate embodiments, the tray could have any suitable type of shape for removably receiving one or more pods. The pods P preferably comprise a molded plastic cup-shaped base and a foil top. The bottom of the molded plastic cup-shaped base preferably has a hole therethrough with a screen or filter across the hole. In an alternate embodiment, the appliance could be configured to puncture a hole in the bottom of the pod. However, in alternate embodiments, the coffee maker 10 could be suitably configured to be used with any suitable type of pod. The pods are preferably sized to provide single individual servings. However, the pods could have sizes for large and small size cups. Alternatively, the pods could be sized for multiple cups, such as when features of the present invention are used in a coffee maker for use with a coffee pod.

The piercing assembly 196 forms a piercing platform which comprises a support member 206, a spring 208, and two piercers 210, 211. The support member 206 has a rear end 212 which is pivotably mounted between the two housing members 198, 199. A front end of the support member 206 has latches 214. The piercers 210, 211 are stationarily connected to the support member 206 at apertures 216. In an alternate embodiment, the piercing assembly could have more or less than two piercers. The piercers 210, 211 have top ends which are respectively connected to the tubes 172, 174. The piercers have bottom ends with pointed shapes. The bottom ends are adapted to pierce through the foil tops of the pods P when the support member 206 is rotated downward. The spring 208 normally keeps the support member 206 in an upward position. The piercers have channels between their top and bottom ends for allowing water from the tubes 172, 174 to pass through the piercers. In an alternate embodiment, the system could comprise a magnetic latch with an automatic release.

In an alternate embodiment, the piercing assembly 196 could include a bypass water tube outlet 213 and the diverter 20 could be a three way diverter with a third water conduiting tube extending therethrough. The diverter could send water to the outlet 213 to bypass the pods P. Thus, a first percentage of hot water could flow into a coffee cup through a pod and a second percentage of hot water could bypass around the pod and into the coffee cup for a mixed mild cup of coffee. This could also occur without a bypass water tube outlet by placing only one pod in the tray 202, but having the diverter set to deliver water to both pierces 210, 211. The water and coffee could combine in a coffee cup or combine into a single stream before delivery into the coffee cup. The bypass might not be provided. A coffee strength control might or might not be provided.

The actuator 194 is located at a front end of the top member 162 of the frame 12. An actuator support 218 is pivotably mounted between the housing members 198, 199 beneath the actuator 194. The actuator 194 rests against the top of the actuator support 218. A spring 220 is provided to bias the actuator support 218 in an up position. Thus, the actuator 194 is normally biased in an up position. The actuator support 218 comprises a pressing section 222 and an arm 224.

A user can press the actuator 194 downward. This results in the actuator support 218 being rotated downward with the pressing section 222 pressing downward on the front end of the support member 206. This causes the front end of the support member 206 to rotate downward. As the front end of the support member 206 rotates downward, the piercers 210, 211 are moved downward to pierce through the top foil of the pods P. The latches 214 can latch with the latch member 226 to retain the support member 206 in its downward position with the piercers 210, 211 projecting inside the pods P. When the user releases the actuator 194, the spring 220 biases the actuator support 218 in an upward direction to move the actuator 194 back to an up position.

The latch member 226 is pivotably connected to the front end of the first member 200 of the drawer 190. The latch member 226 comprises upwardly extending latches 228 and a finger contact section 230. The latch member 226 can retain the support member 206 in its downward position. A user can release the support member 206 from its downward position by pulling forward on the finger contacts section 230. A user usually pulls forward on the finger contact section 230 when the user starts to pull the drawer 190 to an open position.

In an alternate embodiment, the latch member 226 (or movement of the support member 206 back to an up position) could be controlled by a solenoid or a solenoid and spring combination. The solenoid could move the support member 206 to an up position immediately after the controller 24 signals an end of the brewing cycle. This can ensure that the piercers 210, 211 are moved out of the pods P to help prevent bacteria from growing in the piercers when the user does not open the drawer to remove the pods P a long time after brewing has completed (i.e., over a weekend or while away on vacation for a week or more). In alternate embodiments, any suitable type of latch system could be provided, such as a magnetic latch system. A magnetic release could function as a failsafe. If power goes out, the magnetic release could open automatically and lift the piercers from the pod(s).

The sensor 192 generally comprises a printed circuit 232, and three microswitches 234, 235, 236. The sensor 190 is physically connected to the support member 206. The sensor 192 is operably connected to the controller 24. The first microswitch 234 is adapted to be contacted and moved by the arm 224 of the actuator support 218 when the actuator 194 is depressed. Thus, the first microswitch 234 is adapted to signal the controller 24 when a user has depressed the actuator 194. In an alternate embodiment, any suitable type of sensor for sensing when a user has actuated the actuator 194 (or its equivalent) could be provided. The other two microswitches 235, 236 are adapted to be contacted and moved by rear ends of the pods P when the drawer 190 is moved to a closed position.

The rear ends of the pods P (or another suitable section of the pod) preferably have different shapes based upon what is contained inside the pod. For example, a pod having one type of flavored coffee could have one type of rear end shape and a pod having another type of flavored coffee or coffee and artificial sweetener or nondairy creamer could have a different rear end shape. The second and third microswitches 235, 236 are adapted to send a signal to the controller 24 based upon the type of shape of pod rear end which the microswitches sense. This signal is used by the controller 24 to determine what type of pod is present. The controller 24, based upon this determination, can select a predetermined coffee brewing setting for delivery of the water to the pod(s).

In an alternate embodiment, the sensor could be used to merely sense the presence or absence of a pod at a location; not for determining the type of pod present. In alternate embodiments, any suitable type of sensor for sensing the presence or absence of one or more pods in the pod receiving section of the coffee maker could be provided. Alternatively, an alternate embodiment could be provided which did not comprise a pod presence sensor.

The coffee brewing settings are preferably preset in a memory of the controller. The coffee maker would preferably be programmed with multiple coffee brewing setting; such as one for each different type of coffee pod that required different rates of water delivery or different temperatures of water for brewing. Based upon the number or type of pod(s) recognized, the controller would control the volume of water pumped by the pump 54. For the embodiment shown, the controller 24 could do the following:

| | Quantity of |
|---|---|
| | water to be |
| Sensed Pod(s) | pumped |
| A | Q1 |
| B | Q1 |
| C | Q1 |
| A and A | Q2 |
| A and D | Q2 |

Of course, these are only examples. Any suitable variables could be controlled by the controller. In an alternate embodiment, the controller 24 could control the temperature of the heater 18 based upon pod recognition. For example,

| | Quantity of | |
|---|---|---|
| | water to be | |
| Sensed Pod(s) | pumped | Temperature |
| A | Q1 | T1 |
| B | Q1 | T2 |
| C | Q1 | T3 |
| A and A | Q2 | T1 |
| A and D | Q2 | T4 |

The controller could also be programmed to variably control water quantity delivered, and/or speed of the pump and/or temperature of the heater based upon pod recognition. For example:

| | Quantity of | | |
|---|---|---|---|
| | water to be | | |
| Sensed Pod(s) | pumped | Speed of pump | Temperature |
| A | Q1 | S1 | T1 |
| B | Q1 | S2 | T2 |
| C | Q1 | S3 | T3 |
| A and A | Q2 | S1 | T1 |
| A and D | Q3 | S4 | T4 |

or

| | Quantity of | |
|---|---|---|
| | water to be | |
| Sensed Pod(s) | pumped | Speed of pump |
| A | Q1 | S1 |
| B | Q1 | S2 |
| C | Q1 | S3 |
| A and A | Q2 | S1 |
| A and D | Q3 | S4 |

In an alternate embodiment, control could be programmed by a user for individualized results. The pods P could be all the same size and shape, or could include different sizes and shapes. For example, a dual pod could be provided which has two sections; one section being received in each of the apertures 204. The apertures 204 could be reconfigurable to receive different size or shape pods.

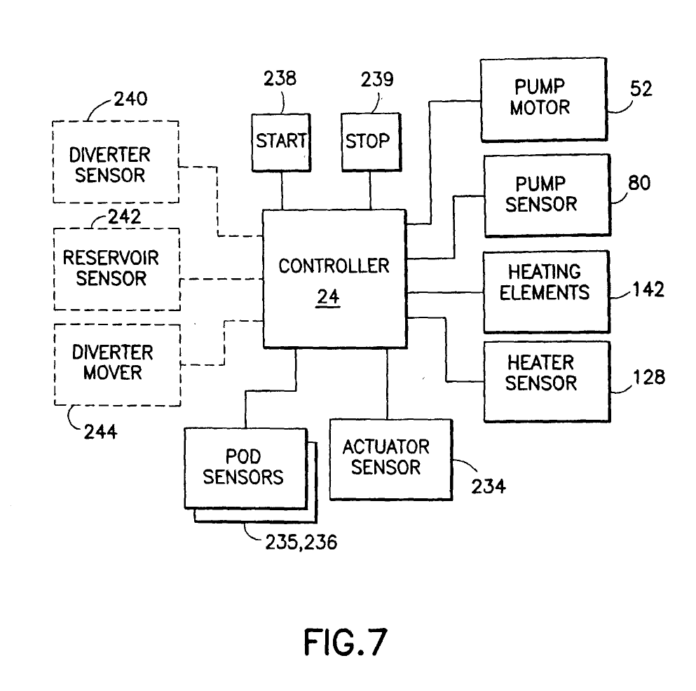

Referring also to FIG. 7, a block diagram of the control system for the coffee maker 10 is shown. In the embodiment shown, the coffee maker 10 includes a start button 238 and a stop button 239 (see FIG. 1). However, in alternate embodiments, any suitable number or type of user interaction controls could be provided. The buttons 238, 239 are operably connected to the controller 24. The controller 24 generally comprises a printed circuit board having a microprocessor and a memory. However, in alternate embodiments, any suitable type of controller could be provided. The pump motor 52, pump sensor 80, heating elements 142, heater sensor 128, actuator sensor 234, and pods sensors 235, 236 are operably connected to the controller 24. A sensor 240, for sensing the state or position of the diverter 20, could be connected to the controller 24. The coffee maker 10 could also comprise a reservoir sensor 242 for sensing the level of the water in the reservoir 14. The reservoir sensor 242 would be operably connected to the controller 24. The coffee maker 10 could also comprise a mover 244 for moving the diverter 20. The diverter mover 244 would be operably connected to the controller 24 such that the controller could control movement of the diverter. All features could be controlled by the controller.

Referring now also to FIG. 8, an alternate embodiment of the coffee pod support tray is shown. The tray 250 in this embodiment comprises two coffee pod receiving seats 252. The receiving seats 252 each comprise sidewalls 254 which extend downward from the tray 250. The sidewalls 254 function as supports for the lateral sides of the coffee pods P. The sidewalls 254 can help substantially maintain the pods P in their original shape even though the relatively hot water might otherwise cause the pods P to warp or bend. The bottom 256 of the receiving seats 252 are substantially open. However, in an alternate embodiment, the bottoms 256 could be partially closed. The tray 250 could also comprise channels from the bottoms 256 to combine streams of coffee from the two seats 252 into a single stream of coffee into a coffee cup.

Referring now to FIG. 9, there is shown a cross sectional view of a top front of an alternate embodiment of a coffeemaker incorporating features of the present invention. In this embodiment, the coffeemaker 300 generally comprises a frame with a pivotably movable lid 302, a multi pod holding system 304 for receiving adjacent coffee pods or condiment pods 306 (only one of which is shown), a coffee pod piercing system 308, a system 310 for preventing a user from contacting needles of the coffee pod piercing system when the coffee pod holding system is in an open position, and a sensing system 312.

The piercing system 308 generally comprises a needle carriage 314 and two needles 316 (only one of which is shown) fixedly mounted to the needle carriage. The needle carriage 314 is pivotably mounted to the lid 302 at pivot point 318. The two needles 316 are attached to the fluid conduit system 320 from the heater and solenoid actuated fluid diverter of the coffee maker.

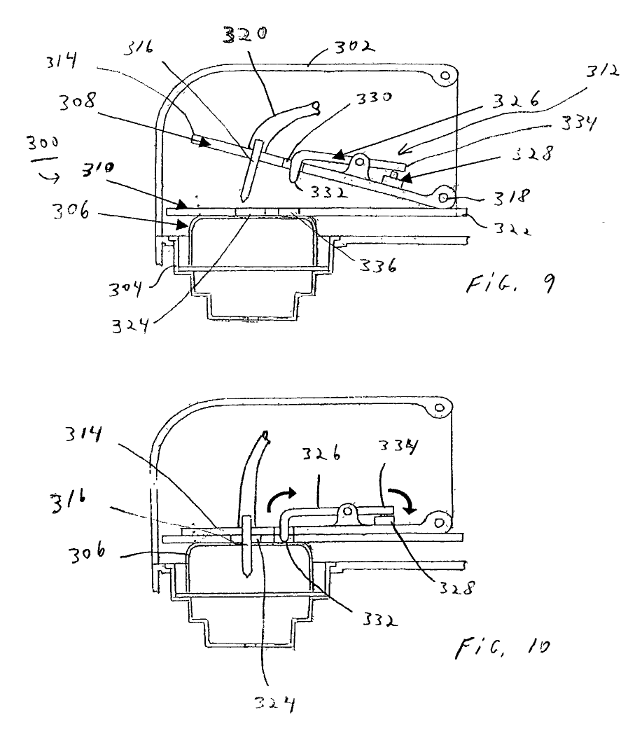

The preventing system 310 generally comprises a shield plate 322 fixedly attached to the lid 302. The shield plate 322 generally comprises a pair of apertures 324 therethrough. The apertures 324 are sized and shaped to allow the needles 316 to respectively extend and retract therethrough. The shield plate 322 forms a bottom of the lid 302 to enclose the components inside the lid except when the bottom ends of the needles 316 extend through the apertures 324 as shown in FIG. 10.

The sensing system 312 generally comprises a pair of mechanical lever arms 326 (only one of which is shown), one for each of the pods 306, pivotably mounted to the needle carriage 314. The sensing system 312 also comprises two switches 328 (only one of which is shown) attached to the needle carriage 314. The needle carriage 314 comprises apertures 330. The lever arms 326 each comprise a first end 332 and a second end 334. The first ends 332 are adapted to extend through the apertures 330. The second ends 334 are adapted to contact the switches 328. The shield plate 322 also comprises apertures 336. The apertures 336 are adapted to allow the first ends 332 of the lever arms 326 to extend therethrough.

Referring also to FIG. 10, the coffee maker is shown with the piercing system 308 located in a downward position such that the needles 316 pierce into the pods 306. In order to obtain this position, the needle carriage 314 is rotated downward against the top side of the shield plate 322. The needles 316 extend through the apertures 324 to pierce through the top sides of the pods 306. The first ends 332 of the lever arms 326 extend through the apertures 336. If one or both pods 306 are present, one or both of the first ends 332 are pushed upward. The lever arms 326 can rotate and actuate one or both of the switches 328. Thus, the sensing system 312 can send signals via the switches 328 to indicate whether or not the pod(s) 306 are present or not in the holder 304.

The embodiment described above uses the two mechanical lever arms which are designed to interfere with the pods when the needle carriage is lowered into its down position. This interference causes the levers to actuate the electrical switches, thereby notifying the unit that one or both of the pods are present or absent. If no pod is present, the lever arm will not actuate the switch. The sensing system can be used to allow the unit to distinguish which pods are present (black only, black and creamy, or creamy only). The sensing system can be used to allow the controller to automatically determine which brew cycle to run (black beverage, creamy beverage, or none if the pods are not installed properly). The sensing system can be used to prevent the unit from running without properly installed pods. The sensing system can also be used to prevent the unit from running with the lid open.

In an alternate embodiment, the electrical switch could be actuated directly by the pod without use of a lever arm. In another alternate embodiment, the shield plate can be designed to act as a mechanical lever arm. The shield can be designed so that it interferes with the pods. This interference would cause the plate to move when a pod is present and actuate the electrical switch.

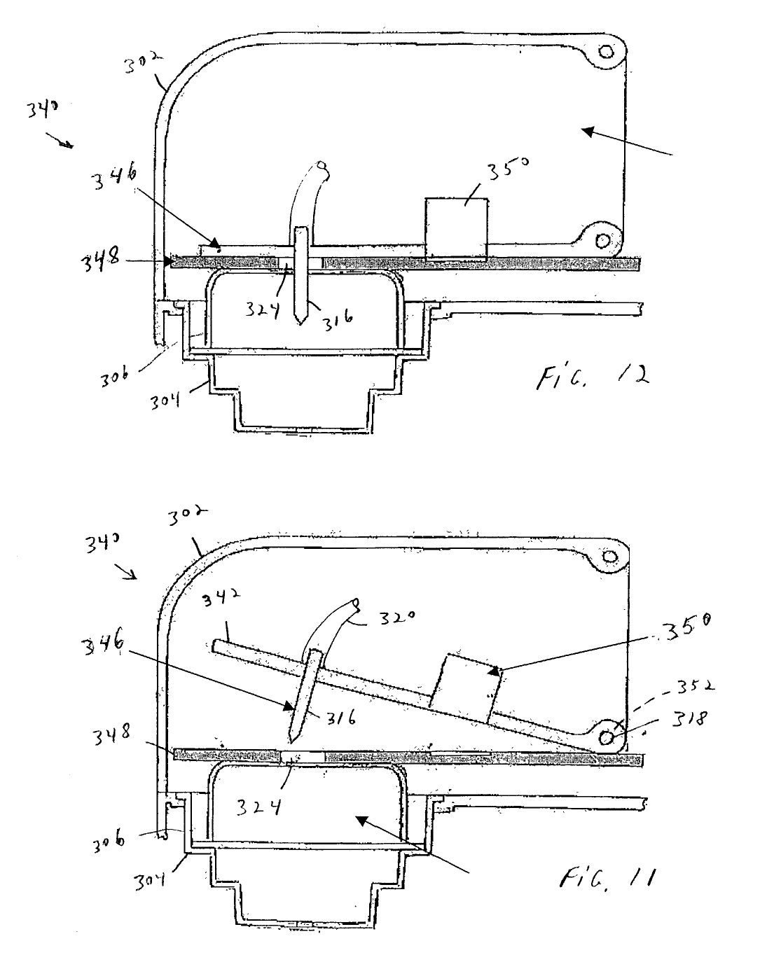

Referring now to FIG. 11, an alternate embodiment of the present invention will be described. This embodiment is substantially similar to the embodiment shown in FIG. 9. The coffee maker 340 generally comprises a frame with a pivotably movable lid 302, a multi-pod holding system 304 for receiving adjacent coffee pods or condiment pods 306 (only one of which is shown), a coffee pod piercing system 346, and a system 348 for preventing a user from contacting needles of the coffee pod piercing system when the coffee pod holding system is in an open position.

The piercing system 346 generally comprises a needle carriage 342 and two needles 316 (only one of which is shown) fixedly mounted to the needle carriage. The needle carriage 314 is pivotably mounted to the lid at pivot point 318. The two needles 316 are attached to the fluid conduit system 320 from the diverter and the heater of the coffee maker. The piercing system 346 also comprises a magnetic latch 350 attached to the needle carriage 342 and the spring 352 which biases the needle carriage 342 in the upward position as shown in FIG. 11.

The preventing system 348 generally comprises a shield plate 344 fixedly attached to the lid 302. The shield plate 344 generally comprises a pair of apertures 324 therethrough. The apertures 324 are sized and shaped to allow the needles 316 to respectively extend and retract therethrough. The shield plate 344 forms a bottom of the lid 302 to enclose the components inside the lid except when the bottom ends of the needles 316 extend through the apertures 324 as shown in FIG. 12.

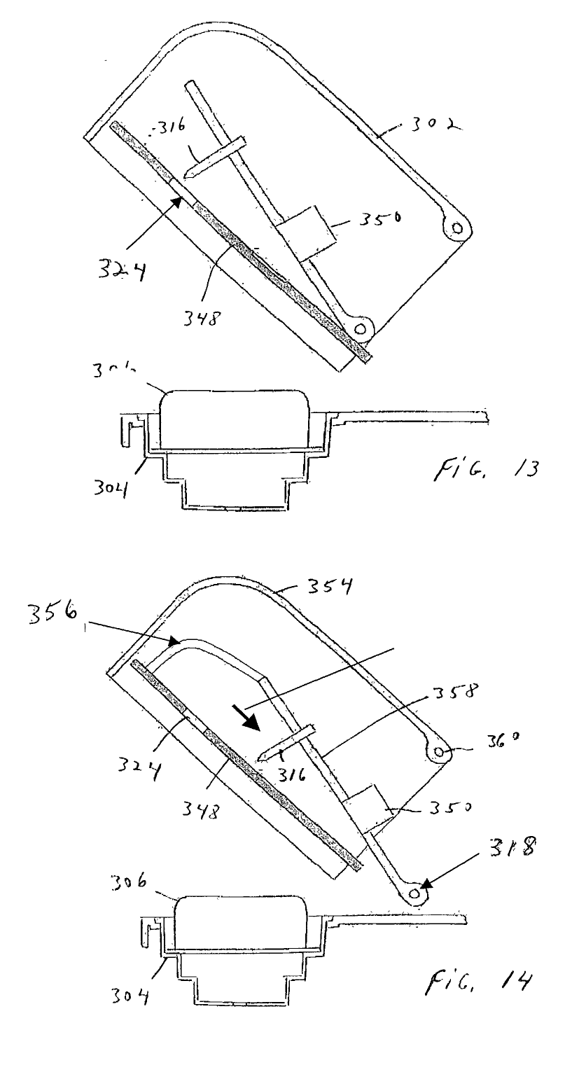

When the piercing system 346 is moved to the downward position shown in FIG. 12, the needles 316 can extend through the apertures 324 to pierce into the pods 306. The magnetic latch 350 is actuated to magnetically retain the needle carriage 342 against the shield plate 344 in the downward position as shown. When the magnetic latch 350 is disengaged, the spring 352 can bias the needle carriage 342 back to its up position as shown in FIG. 11. Alternatively, if a user opens the lid 302 as shown in FIG. 13, the magnetic latch 350 can also be disengaged such, that the piercing system 346 is automatically moved to move the needles 316 out of the apertures 324. This moves the needles 316 into an enclosed position inside the lid 302 such that a user cannot touch the needles 316.

The system as described above can prevent access to the sharp piercing needles 316. The system can allow the lid to be opened adequately for a user to have access to the pod area, but without risk of the user contacting the needles. The system is able to hold the pods in place during both the brewing cycle and also while the needles are retracted.

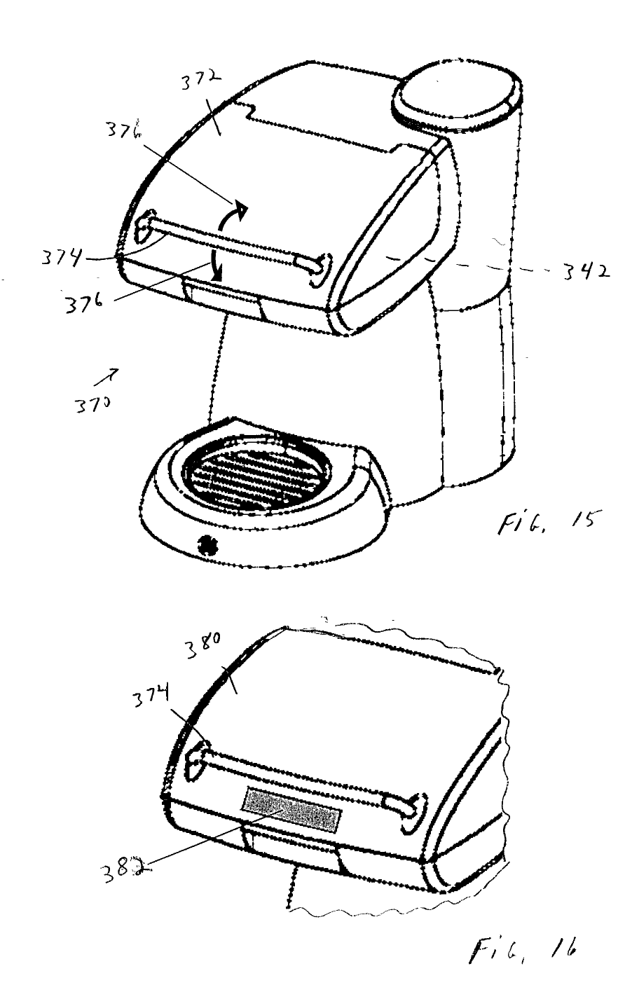

Referring also to FIG. 14, an alternate embodiment of the present invention is shown. In this embodiment, the lid 354 comprises a track 356. A portion of the needle carriage 358, at the front of the needle carriage, is adapted to ride in the track 356. In the embodiment shown in FIG. 11, the needle carriage 342 was pivotably attached to the lid 302. In the embodiment shown in FIG. 14, the needle carriage 358 is pivotably attached to the frame at a different location 318 than the pivotal attachment 360 of the lid 354 to the frame. Thus, the needle carriage 358 is automatically moved relative to the lid 354 when the lid is moved between its open and close positions. As the needle carriage 358 moves from its lid closed position the to the lid open position, the needles 316 can be moved behind the shield plate and out of alignment with the apertures 324.

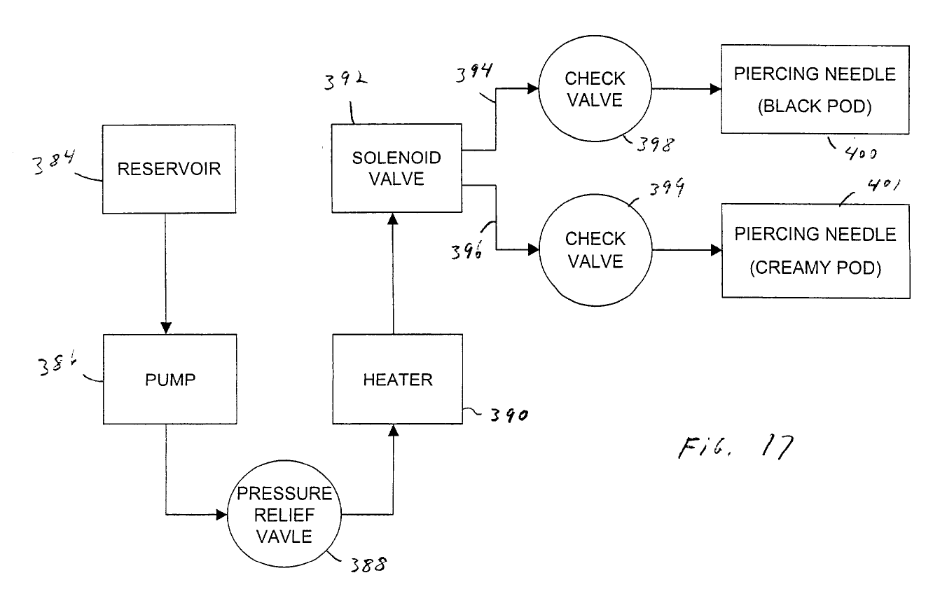

Referring now to FIG. 15, another alternate embodiment of the present invention will be described. In this embodiment, the coffeemaker 370 comprises a front top section with a movable lid 372 and a handle 374. The handle 374 is attached to the needle carriage 342 located under the lid. The handle 374 can be directly attached to the needle carriage, or there could comprise a linkage between the handle and the needle carriage. The handle 374 is movably attached to the lid 372. The handle 374 can rotate upward and downward as illustrated by arrows 376 and 378.

When the handle 374 is in its up position, this could indicate to the user that a brew cycle has ended. When the handle 374 is in a down position, this could indicate to the user that the unit is ready to brew. This type of a visual indication can be appealing to consumers who have expressed dislike for a beeper or buzzer indicator. At the end of a brew cycle, the needle carriage can automatically move upward to a retracted position inside the lid 372. Sound created by action of the automatic movement of the handle and internal needle carriage at the end of a brewing cycle can provide audible indication of a brewing cycle end. The physical change in the handle 374 can clearly indicate the end of a brew cycle.

Referring now to FIG. 16, an alternate embodiment of the end-of-brew indicator is shown. In this embodiment, the lid 380 comprises a window 382. The window can change colors or contain text based on handle position to indicate the status of the brewing cycle.

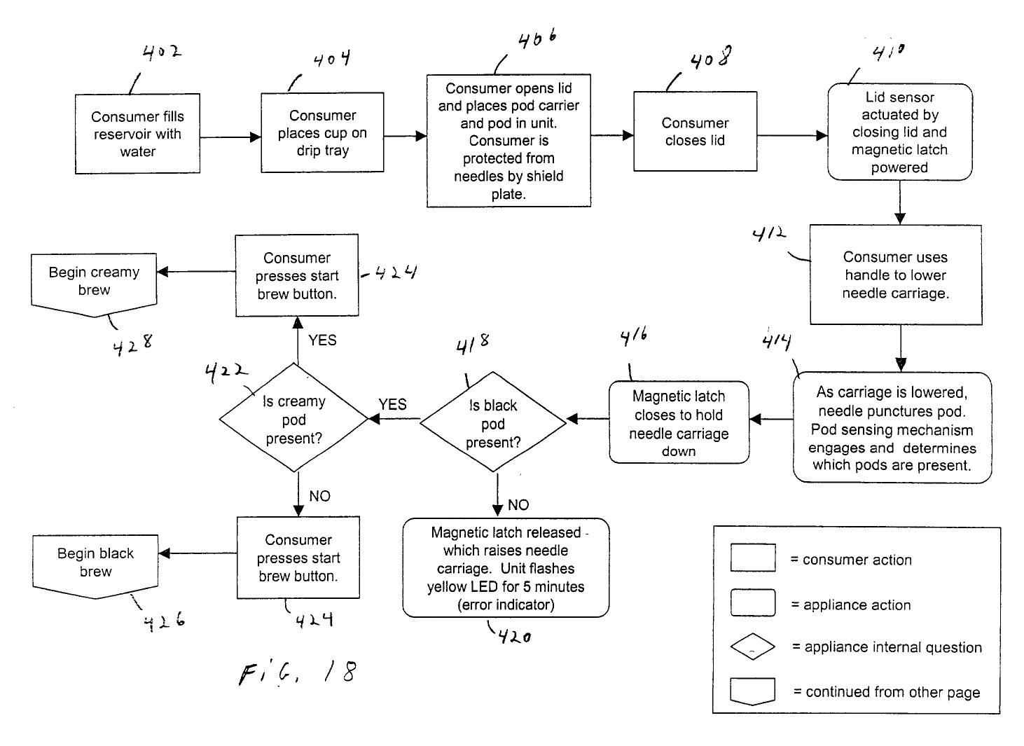

Referring now to FIG. 17, a diagrammatic view of a water flow path through a coffee maker incorporating features of the present invention is shown. In this embodiment, water is taken from the reservoir 384 and pumped by the pump 386 through a pressure relief valve 388 to the heater 390. The water can then travel out of the heater 390 to the solenoid valve 392 where the water can be diverted to one or both of the paths 394, 396 through the check valves 398, 399 and eventually to the piercing needles 400, 401. The first piercing needle 400 is intended to be able to pierce a black coffee pod. The second piercing needle 401 is intended to be able to pierce a creamy pod, such as a pod which contains a creamer for the coffee.

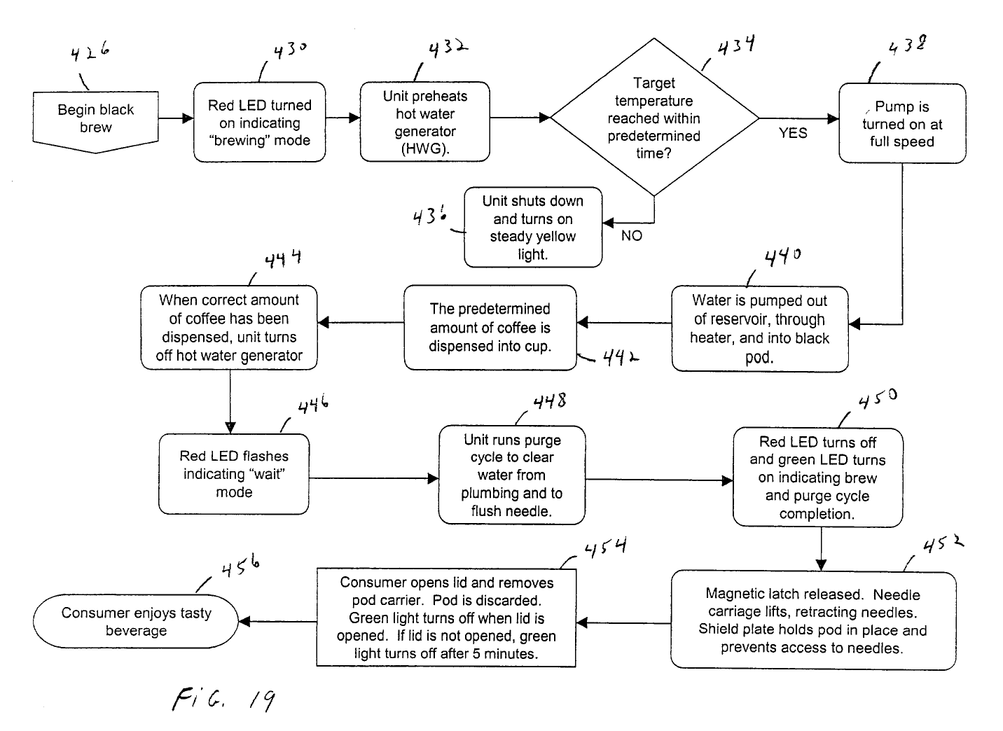

Referring now to FIG. 18, one method of operating a coffee maker which incorporates features of the present invention will be described. Initially, a consumer fills 402 the reservoir with water, places 404 a coffee cup on the trip tray, opens the front lid and places 406 one or more pods in the pod carrier, closes 408 the lid with the lid sensor being actuated 410 and the magnetic latch being powered, and the user then using 412 the handle to lower the needle carriage. As the needle carriage is lowered, the needle(s) puncture 414 the pod(s). The pod sensing mechanism also engages and determines which pod(s) are present. The magnetic latch closes 416 to hold the needle carriage down.

The coffee maker then determines 418 if the black pod is present. If the black pod is not present, then the magnetic latch is released 420 which raises the needle carriage. An indication can be given such as the unit flashing with a yellow LED for five minutes to indicate an error. If the black pod is determined to be present, then the unit determines 422 if the creamy pod is present. The user can then press 424 the start brew button and the unit will then begin either the black brew cycle or the creamy brew cycle.

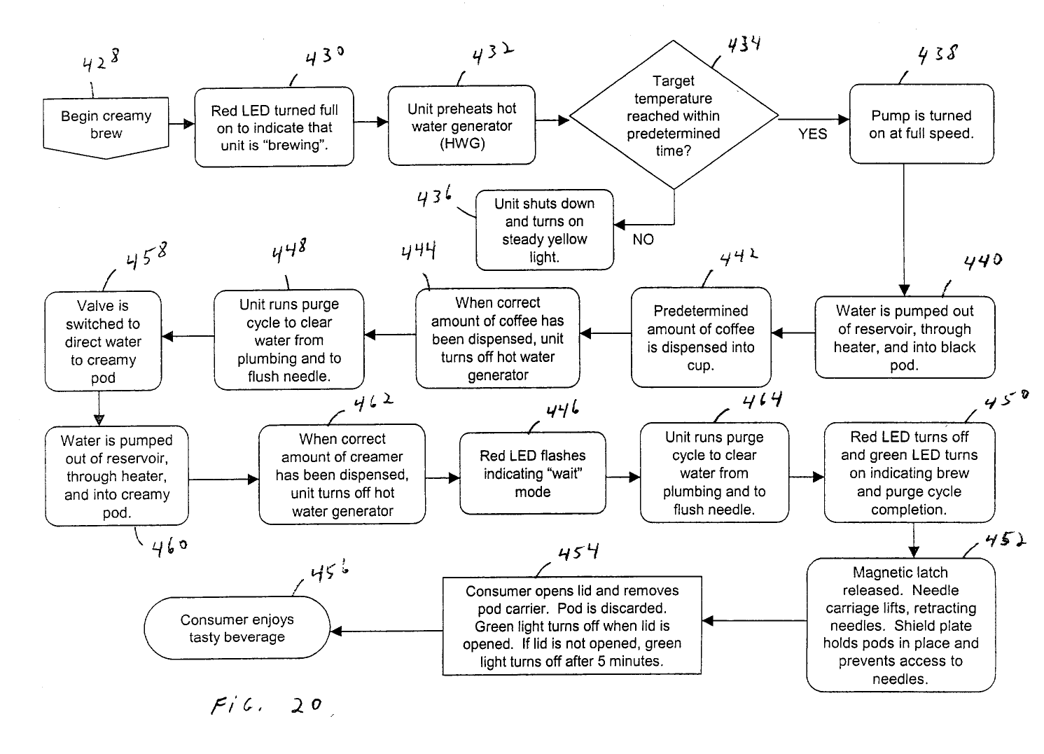

Referring also to FIG. 19, the black brew cycle will now be described. Initially, a red LED can be turned ON 430 to indicate a brewing mode. The unit can preheat 432 the hot water generator. The unit then determines 434 if a target temperature is reached within a predetermined time. The unit will shut down 436 and turn ON a steady yellow light if the target temperature is not reached within the predetermined time.

If the target temperature is reached within the predetermined time, the pump is turned ON 438 at full speed. Water is pumped 440 out of the reservoir, through the heater, and into the black pod. The unit determines 442 when a predetermined amount of the coffee has been dispensed into the cup. When the correct amount of coffee has been dispensed, the unit turns OFF 444 the hot water generator. A red LED can flash 446 to indicate a wait mode. The unit can then run 448 a purge cycle to clear water from the internal plumbing and to flush the needle. The red LED can turn OFF 450 and a green LED can turn ON to indicate brew and purge cycle completion. The magnetic latch can then be released 452 and the needle carriage can lift, retracting the needles. The shield plate can hold the used black pod in place and prevent access to the needles. The consumer can then open the lid and remove the pod carrier 454. The pod can be discarded. The green light can turn OFF when the lid is opened. If the lid is not opened, the green light can turn OFF after a predetermined time, such as five minutes. The user can then enjoy 456 the beverage which has been dispensed into the coffee cup.

Referring now also to FIG. 20, the creamy brewing cycle can be substantially the same as the black brew cycle, but can include four additional steps. After the first purge cycle 448, a valve is switched 458 to direct water to the creamy pod. Water is pumped 460 out of the reservoir, through the heater, and into the creamy pod. When a correct amount of creamer has been dispensed 462, the unit turns OFF the hot water generator. The unit then runs a second purge cycle 464 to clear water from the plumbing and to flush the creamy pod needle.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A coffee maker comprising:
a frame;
a water reservoir connected to the frame;
a peristaltic pump connected to the water reservoir; and
a heater connected to the peristaltic pump;
wherein the frame comprises a coffee pod holder for removably holding a coffee grounds containing pod such that hot water can be received from the heater into the coffee grounds containing pod and liquid coffee can pass out of the coffee grounds containing pod.

2. A coffee maker as in claim 1 wherein the coffee pod holder is adapted to hold the coffee grounds containing pod and at least one other pod at a same time.

3. A coffee maker as in claim 2 further comprising a coffee pod piercing system connected to the frame and having at least two needles connected to a fluid conduit system from the heater, wherein the needles are adapted to respectively pierce through the pods in the coffee pod holder and allow heated water to separately flow into the pods.

4. A coffee maker as in claim 1 further comprising a controller connected to the pump and the heater which is adapted to control the heater and the pump for delivering about eight ounces of water from the outlet of the heater at about 180° F. in about one minute or less from a water supply at about room temperature.

5. A coffee maker as in claim 1 further comprising:
a coffee pod piercing system connected to the frame and having at least one needle connected to a fluid conduit system, wherein the needle is adapted to pierce through the pod in the coffee pod holder and allow heated water to flow into the pod; and
a system for preventing a user from contacting the needle when the coffee pod holder is in an open position.

6. A coffee maker as in claim 5 wherein the coffee pod holder is adapted to hold the coffee grounds containing pod and at least one other pod in a side-by-side orientation, and wherein the coffee pod piercing system comprises two of the needles, each needle being located for piercing respectively through the pods.

7. A coffee maker as in claim 5 further comprising:
a handle connected to the needle for moving the needle into the pod;
a system for automatically moving the needle out of engagement with the pod upon completion of a brewing cycle; and
wherein the handle is moved when the needle is moved such that the handle forms an indicator for indicating completion of the brewing cycle.

8. A coffee maker as in claim 1 further comprising a coffee pod piercing system connected to the frame and having at least two needles connected to a fluid conduit system from the heater, wherein the needles are adapted to pierce through the pod and at least one other pod in the coffee pod holder and allow heated water to flow into the pods, and wherein the fluid conduit system comprises a selectively movable diverter for at least partially diverting flow of water between the two needles.

9. A coffee maker comprising:
a frame;
a fluid conduit system extending through the frame, the fluid conduit system comprising a water heater;
a coffee pod holder connected to the frame, the coffee pod holder being adapted to simultaneously hold at least two pods; and
a coffee pod piercing system connected to the frame and having at least two needles connected to the fluid conduit system which are adapted to respectively pierce through the at least two pods in the coffee pod holder and allow heated water to separately flow into the at least two pods.

10. A coffee maker as in claim 9 wherein the coffee pod piercing system comprises a vertically movable handle connected to the needles for moving the needles to pierce through the pods.

11. A coffee maker as in claim 10 further comprising a system for automatically moving the needles out of engagement with the pods upon completion of a brewing cycle, wherein the handle is moved when the needles are moved such that the handle forms an indicator for indicating completion of the brewing cycle.

12. A coffee maker as in claim 9 further comprising a pump, and a controller connected to the pump and the water heater, wherein the controller is adapted to control the water heater and the pump for delivering about eight ounces of water from the outlet of the water heater at about 180° F. in about one minute or less from a water supply at about room temperature.

14. A coffee maker as in claim 9 further comprising a sensor adapted to separately sense a presence or absence of one or more of the pods on the coffee pod holder.

15. A coffee maker as in claim 9 further comprising a system for preventing a user from contacting the needles when the coffee pod holder is in an open position.

16. A coffee maker comprising:
a frame;
a water heater connected to the frame, the water heater being arranged in a general vertical orientation with an inlet at a bottom and an outlet at a top;
a fluid conduit system connected to the water heater, the fluid conduit system comprising a liquid pump for pumping water into the inlet of the water heater; and
a controller connected to the pump and the water heater which is adapted to control the water heater and the pump for delivering about eight ounces of water from the outlet of the water heater at about 180° F. in about one minute or less from a water supply at about room temperature.

17. A coffee maker as in claim 16 wherein the liquid pump comprises a peristaltic pump.

18. A coffee maker as in claim 17 further comprising a coffee pod holder connected to the frame, the coffee pod holder being adapted to hold at least two pods, and a coffee pod piercing system connected to the fluid conduit system for piercing into the at least two pods and delivering hot water into the pods.

19. A coffee maker comprising:
a frame;
a fluid conduit system extending through the frame, the conduit system comprising a water heater;
a coffee pod holder connected to the frame, the coffee pod holder being adapted to simultaneously hold at least two separate pods; and
a coffee pod sensor adapted to separately sense the presence or absence of the at least two pods in the coffee pod holder.

20. A coffee maker as in claim 19 further comprising a coffee pod piercing system connected to the frame.

21. A coffee maker as in claim 20 wherein the coffee pod sensor is connected to a needle carriage of the coffee pod piercing system.

22. A coffee maker as in claim 21 wherein the coffee pod sensor comprises lever arms pivotably connected to the needle carriage, the lever arms having first ends adapted to contact the pods when the pods are present in the coffee pod holder and switches adapted to be contacted and actuated by second ends of the switches.

23. A coffee maker comprising:
a frame;
a fluid conduit system extending through the frame, the fluid conduit system comprising a water heater;
a coffee pod holder connected to the frame, the coffee pod holder being adapted to hold at least one pod;
a coffee pod piercing system connected to the frame and having at least one needle connected to the fluid conduit system which is adapted to pierce through the at least one pod in the coffee pod holder and allow heated water to separately flow into the pod; and
a system for preventing a user from contacting the needle when the coffee pod holder is in an open position.

24. A coffee maker as in claim 23 wherein the system for preventing a user from contacting the needle comprises a shield plate with an aperture which the needle can extend through.

25. A coffee maker as in claim 24 wherein the needle is movable between a first position in which the needle extends through the aperture and a second position in which the needle does not extend through the aperture.

26. A coffee maker as in claim 25 wherein the needle is attached to a pivotable needle carriage, and wherein the needle carriage comprises a magnetic latch for selectively holding the needle carriage at a first predetermined position relative to the shield plate.

27. A coffee maker as in claim 27 further comprising a spring connected between the needle carriage and the shield plate to bias the needle carriage in a second predetermined position relative to the shield plate.

28. A coffee maker as in claim 24 wherein the shield plate is connected to a lid for opening and closing access to the coffee pod holder, the shield plate moving with the lid.

29. A coffee maker as in claim 28 wherein the needle is attached to a pivotable needle carriage, and further comprising a guide track connection between the lid and the needle carriage to move the needle carriage relative to the lid as the lid is moved.

30. A coffee maker comprising:
a frame comprising a coffee pod holder;
a fluid conduit system extending through the frame, the fluid conduit system comprising a water heater;
a coffee pod piercing system connected to the frame, the coffee pod piercing system comprising a needle for piercing into at least one pod in the coffee pod holder and a handle connected to the needle for moving the needle; and
a system for automatically moving the needle out of engagement with the pod upon completion of a brewing cycle, wherein the handle is moved when the needle is moved such that the handle forms an indicator for indicating completion of the brewing cycle.

31. A coffee maker as in claim 30 wherein the frame comprises a movable lid above the coffee pod holder, and wherein the lid comprises a window for viewing a brew indicator connected to the handle.

32. A method of making coffee in a coffee maker comprising steps of:
inserting at least two pods into the coffee maker;
piercing into the pods at substantially a same time by needles; and
delivering heated water to the pods through the needles, wherein contents of the pods are at least partially mixed with the heated water and dispensed from the coffee maker.

33. A method as in claim 32 wherein the step of piercing into the pods comprises a user moving a user actuated handle of the coffee maker from a second position to a first position.

34. A method as in claim 33 further comprising indicating an end of a brew cycle in the coffee maker comprising steps of:
automatically moving the needles out of engagement with the pods in the coffee maker at the end of the brew cycle; and
moving the user actuated handle from the first position to the second position on a housing of the coffee maker when the needles are moved out of engagement with the pods, wherein the user actuated handle is mechanically connected to the needles, and wherein the movement of the user actuated handle to the second position indicates the end of the brew cycle.

35. A method as in claim 32 wherein the step of delivering heated water to the pods comprises:
pre-heating a water heater of the coffee maker to a predetermined temperature;
pumping water through the water heater at a substantially constant flow rate; and
delivering the heated water from the water heater to the pods,
wherein the pump and the water heater are controlled by a controller for delivering about eight ounces of water from the outlet of the heater at about 180° F. in about one minute or less, from a water supply at about room temperature.

36. A method as in claim 32 wherein the step of delivering the heated water to the pods comprises selectively diverting the heated water between the needles.

37. A method as in claim 36 wherein the step of selectively diverting the heated water between the needles comprises a controller automatically, selectively moving a diverter valve.

38. A method as in claim 37 wherein the step of automatically, selectively moving a diverter valve by the controller comprises moving the valve during an intermediate time during the step of delivering the heated water to the pods.

39. A method of indicating an end of a brew cycle in a coffee maker, the method comprising steps of:
automatically moving at least one pod piercing needle out of engagement with at least one pod in the coffee maker at the end of the brew cycle; and
moving a user actuated control from a first position to a second position on a housing of the coffee maker when the pod piercing needle is moved out of engagement with the pod, wherein the user actuated control is mechanically connected to the pod piercing needle, and wherein the movement of the user actuated control to the second position indicates the end of the brew cycle.

40. A method as in claim 39 wherein the step of automatically moving the pod piercing needle comprises moving the needle behind a shield plate attached to a movable lid of the coffee maker.

41. A method as in claim 40 wherein the user actuated control comprises a handle movably extending through the lid.

42. A method as in claim 41 wherein the lid comprises a window, and a brew cycle indicator is mechanically attached to the handle and is located behind the window and adapted to be moved relative to the window.

43. A method as in claim 39 wherein the step of automatically moving the pod piercing needle comprises a controller of the coffee maker releasing a needle carriage holding latch which held the needle at a piercing position.

44. A method as in claim 43 wherein the controller is adapted to release the latch upon completion of about eight ounces of water flowing out of the outlet of the heater.

45. A method as in claim 43 wherein the step of automatically moving the pod piercing needle further comprises biasing a needle carriage having the needle attached thereto to a retracted position for locating the needle in a retracted position behind a shield plate attached to a movable lid of the coffee maker.

46. A method of making coffee in a coffee maker comprising steps of:
pre-heating a water heater of the coffee maker to a predetermined temperature;
pumping water through the water heater at a substantially constant flow rate; and
delivering heated water from the water heater to at least one pod having coffee grounds therein,
wherein the pump and the water heater are controlled by a controller for delivering about eight ounces of water from the outlet of the heater at about 180° F. in about one minute or less from a water supply at about room temperature.

47. A method as in claim 46 further comprising:
inserting the pod and at least one other pod into the coffee maker;
piercing into the pods at substantially a same time by needles; and
delivering the heated water to the pods through the needles, wherein contents of the pods are at least partially mixed with the heated water and dispensed from the coffee maker.

48. A method as in claim 47 wherein the step of delivering the heated water to the pods through the needles comprises moving a water flow diverter connected between the water heater and the needles from a first position to a second position.

49. A method as in claim 48 wherein the step of moving the water flow diverter comprises a controller of the coffee maker automatically moving the water flow diverter at a predetermined time during the brew cycle.

50. A method as in claim 46 wherein the step of delivering the heated water to the pods comprises moving a water flow diverter connected between the water heater and the pods from a first position to a second position.

51. A method as in claim 50 wherein the step of moving the water flow diverter comprises a controller of the coffee maker automatically moving the water flow diverter at a predetermined time or event during the brew cycle.

52. A method as in claim 46 further comprising indicating an end of a brew cycle in the coffee maker comprising steps of:
automatically moving a pod piercing needle out of engagement with the pod at the end of the brew cycle; and
moving a user actuated handle from a first position to a second position on the housing of the coffee maker when the needle is moved out of engagement with the pod, wherein the user actuated handle is mechanically connected to the needle, and wherein the movement of the user actuated handle to the second position indicates the end of the brew cycle.

53. A method as in claim 52 wherein the step of automatically moving the pod piercing needle further comprises a controller of the coffee maker releasing a needle carriage holding latch which held the needle at a piercing position.
